(19) United States
(12) Patent Application Publication
(10) Pub. No.: US 2018/0039741 A1
(43) Pub. Date: Feb. 8, 2018

(54) MOBILE SYSTEM AND METHOD FOR MONITORING AND/OR LEVERAGING CANNABINOID LEVELS IN THE BLOOD OF A USER

(71) Applicant: George Trudell, JR., San Diego, CA (US)

(72) Inventor: George Trudell, JR., San Diego, CA (US)

(21) Appl. No.: 15/652,726

(22) Filed: Jul. 18, 2017

Related U.S. Application Data
(60) Provisional application No. 62/398,299, filed on Sep. 22, 2016.
(60) Provisional application No. 62/370,091, filed on Aug. 2, 2016.

(51) Int. Cl. G06F 19/00

(52) U.S. Cl. CPC G06F 19/326

(57) ABSTRACT

A system for leveraging user data based on a presence of at least one cannabinoid in the blood of a user includes a database, a device application, and a controller. The database is configured to store the user data. The device application is adapted for use on a computing device accessible by the user. The device application is configured to receive the user data of the user, and upload the user data to the database. The controller includes a processor that is configured to control operation of the device application. The user data can include subjective information based on the presence of the at least one cannabinoid in the blood of the user, and objective information relating to a measurement of a level of the at least one cannabinoid in the blood of the user. An administrative entity can also have access to the user data stored within the database.

### RELATED APPLICATIONS

This application claims priority on U.S. Provisional Application Ser. No. 62/370,091, filed on Aug. 2, 2016, entitled “MOBILE SYSTEM AND METHOD FOR MONITORING AND/OR LEVERAGING BLOOD TETRAHYDROCANNABINOL LEVELS”; and U.S. Provisional Application Ser. No. 62/398,299, filed on Sep. 22, 2016, entitled “MOBILE SYSTEM AND METHOD FOR MONITORING AND/OR LEVERAGING BLOOD TETRAHYDROCANNABINOL LEVELS”. As far as permitted, the contents of U.S. Provisional Application Ser. Nos. 62/370,091 and 62/398,299 are incorporated herein by reference.

### BACKGROUND

Use of medical and recreational marijuana (or cannabis) is becoming legal across various jurisdictions in North America and globally. Marijuana can generally be lumped into three different categories: indica, sativa, and a hybrid (indica/sativa). Additionally, within each marijuana type there are also various strains. Further, each type and strain of marijuana can have a certain potency level based on the presence of various cannabinoids within the marijuana. There are many cannabinoids that can be found within the cannabis plant, including cannabigerol (CBG), cannabichromene (CBC), cannabidiol (CBD), tetrahydrocannabinol (THC), cannabinol (CBN), cannabinodiol (CBDL), cannabicyclol (CBL), cannabielsoin (CBE), cannabitriol (CBT), and many others. Of these, the most well-known are cannabidiol (CBD), which is typically recognized as the substance responsible for many of the medicinal and therapeutic properties associated with medical marijuana, and tetrahydrocannabinol (THC), which is the primary psychoactive compound of the cannabis plant.

With the increasing legalization of medical and recreational marijuana, the number of people who now use marijuana in some form or another is also rapidly increasing. This presents a significant challenge to law enforcement to keep roads safe from drivers who are impaired after using marijuana. Current marijuana enforcement typically relies on an officer's opinion as to the impairment of drivers due to the use of marijuana (e.g., due to the presence of tetrahydrocannabinol (THC) in the user's system). Additionally, human resource departments also have a similar interest in keeping work environments safe from employees, e.g., employees who are required to use and operate heavy equipment during the course of their employment, who are impaired due to marijuana use. Further, schools, hospitals, clinics and other treatment facilities where employees regularly interact with students/patients may also have an interest in protecting the students/patients from employees who are impaired due to marijuana use.

Testing of blood alcohol content (BAC) is well known, particularly for drivers of motor vehicles of all types. The legislature in each state (and many countries) has established a percentage at which alcohol intoxication is presumed for legal or medical purposes. However, unlike BAC testing, which can be accurately measured using a breathalyzer, testing for THC has many more challenges. For example, THC detection is typically much more time-consuming. Further, with the somewhat limited testing that has been previously done as to THC levels in individuals, it can be difficult to determine the level of impairment, if any, of an individual solely based on the amount of THC that may be detected in the blood of an individual. Thus, it is desired to increase the simplicity of testing for and reporting of THC levels in individuals in a non-invasive manner, as well as being able to more accurately associate a given THC level in an individual's system to a presumed level of impairment.

Additionally, with the increasing use of medical and recreational marijuana, it is further desired to provide medical and recreational marijuana users with a way in which to quickly and easily share information relating to their personal experiences with different types and strains of marijuana. For example, medical marijuana users need a way to track and communicate the degree of symptom or condition alleviation that they experience upon use of different types and strains of marijuana. Further, recreational users may also desire a way in which to communicate their level and intensity of high to fellow marijuana users based on their use of different types and strains of marijuana.

### SUMMARY

The present invention is directed toward a system for leveraging user data of a user based on a presence of at least one cannabinoid in the blood of the user. In various embodiments, the system includes a database, a device application, and a controller. The database is configured to store the user data. The device application is adapted for use on a computing device and is accessible by the user. The device application is configured to (i) receive the user data of the user based on the presence of the at least one cannabinoid in the blood of the user, and (ii) upload the user data to the database. In certain non-exclusive alternative embodiments, the device application may be installed or downloaded onto the computing device, or can be accessed by way of a mobile web link. The controller includes a processor that is configured to control operation of the device application.

In certain embodiments, the user data includes subjective information as provided by the user, the subjective information including at least one of (i) a type, strain and potency of marijuana consumed by the user, (ii) a method of consumption of the marijuana consumed by the user, and (iii) a location of purchase of the marijuana consumed by the user. In some such embodiments, the presence of at least one cannabinoid in the blood of the user includes tetrahydrocannabinol, and the subjective information further includes a subjective evaluation of a type and intensity of high experienced by the user based on the presence of the tetrahydrocannabinol in the blood of the user. In other such embodiments, the presence of at least one cannabinoid in the blood of the user includes cannabidiol, and the subjective information further includes a subjective evaluation of a degree or extent of symptom and condition alleviation for the user based on the presence of the cannabidiol in the blood of the user.

Further, in some embodiments, the user data includes objective information relating to a measurement of a level of the at least one cannabinoid in the blood of the user. Additionally, the system can further include a measurement device that is configured to measure the level of the at least one cannabinoid in the blood of the user. In alternative embodiments, the measurement device can be embedded within the computing device, or the measurement device can be provided externally from the computing device.

In certain embodiments, the user can include objective information as noted above, as well as subjective information as provided by the user, the subjective information including at least one of (i) a type, strain and potency of marijuana consumed by the user, (ii) a method of consumption of the marijuana consumed by the user, and (iii) a location of purchase of the marijuana consumed by the user.

Additionally, the system can further include an administrative device application that is provided within an administrative computing device and that is accessible by an administrative entity, the administrative device application providing the administrative entity with access to the user data stored within the database.

As provided herein, the present invention is further directed toward a method for leveraging user data of a user based on a presence of at least one cannabinoid in the blood of the user, the including comprising the steps of (A) receiving the user data of the user based on the presence of the at least one cannabinoid in the blood of the user within a device application that is adapted for use on a computing device and that is accessible by the user; (B) uploading the user data to a database with the device application; (C) storing the user data within the database; and (D) controlling the operation of the device application with a controller including a processor.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of an embodiment of a mobile system for monitoring and/or leveraging cannabinoid levels in the system of a user having features of the present invention;

FIG. 2 is a flowchart that illustrates a representative example of the general operation of the mobile system illustrated in FIG. 1;

FIG. 3A is a simplified illustration of a sample output from a database that can be utilized within the mobile system illustrated in FIG. 1;

FIG. 3B is another simplified illustration of a sample output from the database;

FIG. 4 is a flowchart that illustrates another representative example of the general operation of the mobile system illustrated in FIG. 1;

FIG. 5A is a simplified schematic illustration of another embodiment of the mobile system;

FIG. 5B is a simplified schematic illustration of still another embodiment of the mobile system;

FIG. 5C is a simplified schematic illustration of yet another embodiment of the mobile system;

FIG. 6 is a flowchart that illustrates a representative example of the general operation of the mobile system illustrated in FIG. 5A or FIG. 5B;

FIG. 7 is a flowchart that illustrates a representative example of the general operation of the mobile system illustrated in FIG. 5C;

FIG. 8 is a flowchart that illustrates another representative example of the general operation of the mobile system illustrated in FIG. 5A or FIG. 5B;

FIG. 9 is a flowchart that illustrates another representative example of the general operation of the mobile system illustrated in FIG. 5C; and

FIG. 10 is a flowchart that illustrates still another representative example of the general operation of the mobile system.

### DESCRIPTION

Embodiments of the present invention are described herein in the context of a system and method for monitoring and/or leveraging cannabinoid levels in the system of a user. As provided herein, any and all embodiments of the present invention can be implemented in the form of a device application (or “app”) that can be installed or downloaded within a computing device. The app can be designed to function in English or any other suitable language. The computing device can be a mobile computing device, such as a smartphone, a tablet, a laptop computer, a smart watch or other wrist-based computing devices, etc., or the computing device can be a fixed computing device such as a desktop computer. Additionally, in various embodiments, the app can be used in conjunction with and/or can incorporate the use of a measurement device for purposes of monitoring the levels of various cannabinoids in the blood of the user. Further, the app can further be utilized in conjunction with a controller that is present within the computing device. The controller can include one or more processors and circuits, and can utilize certain specified algorithms built into the app in order to perform certain functions as laid out in greater detail herein below.

As provided herein, the system and method can be utilized by various different types of users and for various different purposes. For example, such users can include law enforcement, i.e. police department staff, fire department staff, probation officers, court systems, etc., human resources departments, schools, hospitals and emergency medical personnel, clinics, treatment facilities, or other suitable administrative entities for purposes of effectively regulating the activities of certain users. Additionally, such other administrative entities can include supervisory entities such as caregivers, overseers, parents or other legal guardians, etc., who may use the system and method for purposes of monitoring the use of marijuana by those for whom they are responsible.

Further, in other embodiments, the system and method can be utilized by medical marijuana users for purposes of recording and sharing information relating to the ability of certain types and strains of marijuana to effectively alleviate certain symptoms or conditions that may be experienced by the user. Medical marijuana users can also use this system and method to more formally document marijuana usage in its medicinal capacity as a means to avoid discipline that may otherwise be forthcoming due to use of marijuana, e.g., to get a waiver from federal law restrictions and thus avoid potential dismissal from employment. Additionally, in still other embodiments, the system and method can be used by recreational marijuana users who want to record and share their subjective experiences, e.g., type and intensity of “high”, based on the use of particular types and strains of marijuana.

Still further, in yet other embodiments, the system and method can be used as a research tool by drug counselors for purposes of documenting the ability of different types and strains of marijuana to treat addictions to other drugs such as heroin, methamphetamine, etc., and/or as a means to track and monitor cannabis usage in relation to potential opioid addiction and the treatment thereof. Similar research usage can also be undertaken by mental health professionals and therapists for purposes of monitoring effects of different types and strains of marijuana on their patients.

Yet further, in other embodiments, the system and method can be utilized as a marketing tool for those involved in the marijuana business, e.g., marijuana growers, cannabis dispensaries, stores, etc.

Those of ordinary skill in the art will realize that the following detailed description of the present invention is illustrative only and is not intended to be in any way limiting. Other embodiments of the present invention will readily suggest themselves to such skilled persons having the benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

As noted above, marijuana can generally be lumped into three different types, i.e. indica, sativa, and hybrid (indica/sativa). Additionally, there are also various strains of marijuana within each marijuana type. Further, within each type and strain of marijuana there is an associated potency based on the levels of the various cannabinoids that exist within the cannabis plant. As noted above, there are many cannabinoids that can be found within the cannabis plant, including cannabigerol (CBG), cannabichromene (CBC), cannabidiol (CBD), tetrahydrocannabinol (THC), cannabinol (CBN), cannabinodiol (CBDL), cannabicyclol (CBL), cannabielsoin (CBE), cannabitriol (CBT), and many others. Of these, the most well-known are cannabidiol (CBD), which is generally recognized as the substance responsible for many of the medicinal and therapeutic properties associated with medical marijuana, and tetrahydrocannabinol (THC), which is the primary psychoactive compound of the cannabis plant, i.e. the compound that gets the user “high”.

It is appreciated that although the description provided herein mostly focuses on the presence and measured levels of CBD and THC in the system of the user, the present invention is equally applicable for purposes of monitoring the levels of any and all cannabinoids within the system (e.g., blood, sweat, saliva, etc.) of the user. Thus, the primary focus on CBD and THC in the present description is not intended to be limiting in any manner.

Additionally, it is further appreciated that the presence of cannabinoids in the system of the user can be realized in any suitable manner. For example, the presence of cannabinoids in the system of the user can be realized through normal consumption of marijuana in its leafy form. Alternatively, the presence of cannabinoids in the system of the user can be realized through the ingestion or other use of oils extracted from the cannabis plant, hashish (cannabinoid resin), or other fabricated forms of cannabinoids known to those skilled in the art, or in another suitable manner.

Further, it is also appreciated that the present invention can additionally be utilized for purposes of monitoring and/or leveraging the presence and level of alcohol or other compounds or substances in the blood of the user. In such alternative applications, the present invention can still be utilized by any and all potential users as described herein.

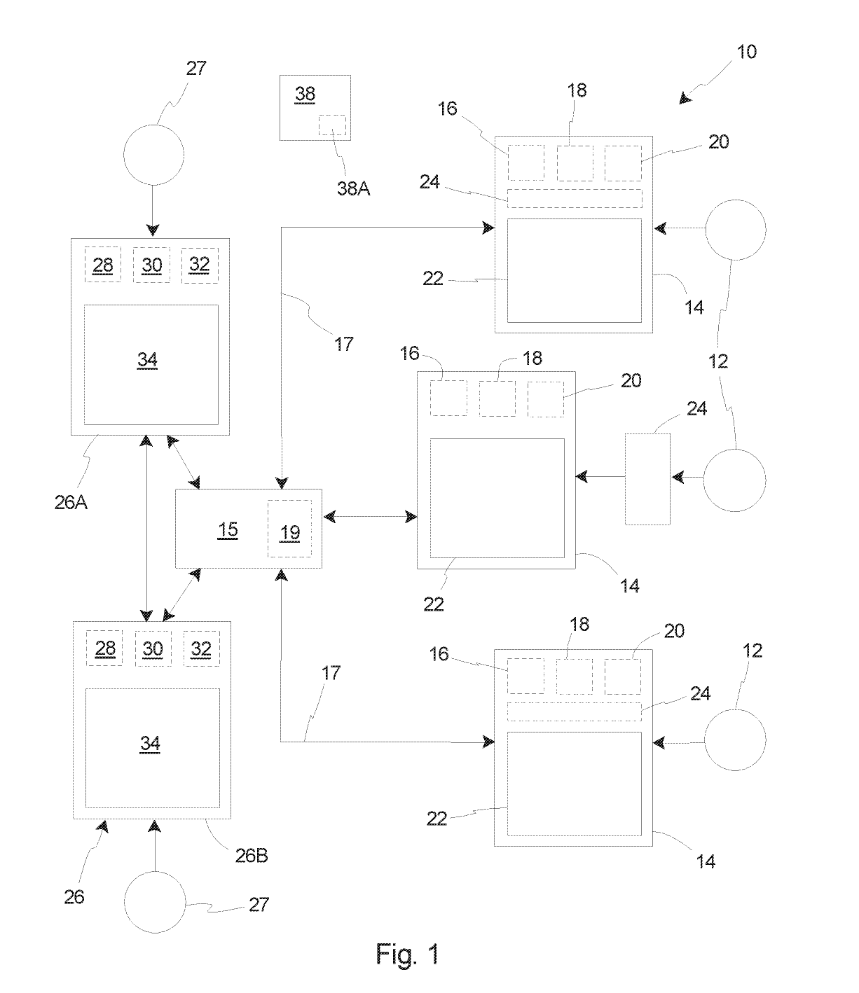

FIG. 1 is a simplified schematic illustration of an embodiment of a mobile system 10 (hereinafter sometimes referred to simply as a “system”) for monitoring and/or leveraging cannabinoid levels in the system of a user having features of the present invention. The design of the mobile system 10 can be varied. More specifically, the mobile system 10 can include more components or fewer components than those specifically illustrated in FIG. 1 and described in detail herein below. For example, in some embodiments, the system 10 can include various connectors, hardware, software and firmware not specifically illustrated, but which can greatly enhance the overall functionality of the system 10.

As illustrated, in various embodiments, the mobile system 10 is intended to be accessed and used by at least one user 12 (three are illustrated simply as circles in FIG. 1). Each user 12 is illustrated in FIG. 1 as having access to a computing device 14, e.g., a mobile computing device (or simply a “mobile device”), that incorporates features of the present invention. In certain embodiments, the computing device 14 accessed by the user 12 can be a wired, wireless and/or mobile computing device such as a smartphone, a tablet, a laptop computer, a smart watch or other wrist-based computing device. Alternatively, the computing device 14 accessed by the user 12 need not be a mobile computing device, i.e. the computing device 14 can be a wired, wireless and/or fixed computing device such as a desktop computer.

Additionally, as shown, the system 10 can further include one or more servers 15 (only one server 15 is illustrated in FIG. 1) which is operatively connected with each of the computing devices 14 using a communications network 17, such as the Internet. Alternatively, in other embodiments, the system 10 can also effectively be used in an Intranet environment. Still alternatively, the system 10 can be used in a Wide Area Network (WAN) and/or a Local Area Network (LAN) setting. Moreover, the present invention performs equally well in a wired network over which the information is transmitted, or in a wireless environment.

In some embodiments, the server 15 can function as part of a non-distributed network which includes at least one database 19 (illustrated in phantom) that stores data. As used herein, the term “database” can include one or more software applications, and/or one or more web applications that interface with and/or connect to the database 19 to perform the functions provided herein. Alternatively, the server 15 can be part of a distributed network that utilizes a plurality of components or nodes in one or more separate geographical locations, with each component performing one or more separate functions of the system 10. In the embodiment illustrated in FIG. 1, the server 15 can manage and/or control functions related to communications among and between the computing devices 14, as well as data and other information or communication transfers between the at least one database 19 and the computing devices 14. Stated in another manner, the system 10 can include, incorporate and/or otherwise utilize the server 15 and/or the database 19 for receiving, compiling and storing any relevant user data from the computing device 14 that may be transmitted to and/or utilized within the system 10.

The server 15 includes computer hardware and/or firmware that can have one or more processors. Further, the server can include software (not shown) that interfaces with and/or connects to the database 19.

Additionally, the server 15 can also communicate with the communications network 17 through a local connection and a service provider to the network 17. The server 15 can store all transmitted user data in the database 19, which can be a Structured Query Language (SQL) database, for example. Further, the server 15 can access the communications network 17 to transfer or transmit information and/or data to the computing devices 14.

In certain embodiments, the server 15 and database 19 can be provided exclusively for use within the system 10. Alternatively, the server 15 and/or the database 19 included, incorporated and/or utilized within the system 10 can be more broadly accessible for this and other purposes, i.e. the system 10 can utilize an already existing server 15 and database 19 including a cloud-based server 15 and database 19.

As provided herein, each user 12 can have a unique user identifier that allows such user 12 to access the database 19 using any or all of the computing devices 14. Alternatively, each of the computing devices 14 can have an address associated with it that the server 15 uses in connection with communication transfers. Additionally, the server 15 has an address that enables desired communications from the computing devices 14 to reach the server 15 in the context of initiating the transmittal, storage and/or retrieval of data. Moreover, in one embodiment, the data transmitted between the server 15 and the computing devices 14 is encrypted using Secure Sockets Layer (SSL) or another suitably effective data encryption method.

In some embodiments, the server 12 can include a plurality of server units forming a server array (not shown) that can function as a multi-processing unit capable of handling requests and/or queries from a substantial number of computing devices 14, e.g. thousands or millions. With this design, a large number of data transfers can occur simultaneously from a plurality of computing devices.

The communications network 17 can include a number of communication sub-systems or apparatuses. Each computing device 14 is able to electronically communicate with the communications network 17 using an Internet Service Provider (ISP), an online service provider and/or a wireless connection. Access to such service providers can be achieved through any suitable communications connection from each computing device 14. However, the system 10 operates equally as effectively even when the computing devices 14 are electrically decoupled from one another and/or the database 19.

In various embodiments, installed, downloaded and/or provided within each computing device 14 is a device application 16 (or “app”, illustrated in phantom) through which the user 12 can effectively gain access to the system 10. Alternatively, in other embodiments, the device application 16 can be accessed by way of a mobile web link from the computing device 14.

Additionally, as shown in FIG. 1, each mobile device 14 can further include a controller 18 (illustrated in phantom), a memory 20 (illustrated in phantom), and an audio/video assembly 22.

Further, the system 10 can also include a measurement device 24 that can be configured to measure levels of cannabinoids within the blood of the users 12. The measurement device 24 can measure levels of cannabinoids within the blood of the users 12 in any suitable manner. For example, the measurement device 24 that can be used with the system 10 can include a device that measures cannabinoid amounts/levels via an individual's breath, perspiration, saliva, mucous membrane swabbing, blood, urine, or any other suitable method for measurement of cannabinoid levels in the blood of the users 12. In some embodiments, the measurement device 24 can be configured to provide continuous or ongoing testing for cannabinoid amounts/levels in the blood of the users 12, e.g., via skin patch, wearable device, etc. In certain embodiments, the measurement device 24 can measure the level of cannabinoids such as THC and CBD in the blood of the individual (e.g., in picograms). In some such embodiments, as illustrated in FIG. 1, the measurement device 24 can be included or incorporated within the computing device 14. Stated another way, the measurement device 24 can be embedded in, or can otherwise be part of the computing device 14, e.g., the mobile device. Alternatively, in other such embodiments, the measurement device 24 can be provided separately from or outside of the computing device 14. In such alternative embodiments, the measurement device 24 can be coupled to the computing device 14, and thus the device application 16, wirelessly or via a suitable wired connection.

As illustrated in FIG. 1, this embodiment of the mobile system 10 is intended to be used effectively by an administrative entity such as law enforcement, a human resources department, schools, hospitals, clinics, treatment facilities, or other similar administrative entities that have an interest in monitoring the cannabinoid levels of other individuals, e.g., the users 12. As such, the mobile system 10 can further include at least one administrative computing device 26, e.g., a mobile administrative computing device 26A and/or a desktop administrative computing device 26B, that is accessible by an administrative entity 27. Each administrative computing device 26A, 26B can include an administrative device application 28 that enables the administrative entity personnel to access the system 10, as well as an administrative device controller 30, an administrative device memory 32, and an administrative device audio/video assembly 34. Additionally, the administrative computing devices 26A, 26B can further communicate, e.g., wirelessly or via a wired connection, with the server 15 and/or the database 19, as well as being able to communicate with one another. With the inclusion of the administrative computing device(s) 26 providing access to the system 10 for various administrative entity personnel, the system 10 can have the ability to track multiple users 12 via a desktop, laptop or any other suitable method and/or website (cloud).

As provided in greater detail herein below, it is understood that each device application 16 and each administration device application 28 can be designed to include different features and to operate somewhat differently depending on the intended use of the application 16, 28. For example, it is appreciated that the individual users 12 and the administrative entities 27 will likely have a different focus as to how best to utilize the system 10. Additionally, as noted, the application 16, 28 can be utilized in conjunction with the controller 18, 30, respectively, to effectively control the collection, compiling, storage and leveraging of any and all user data and information related to the use of marijuana by the at least one user 12 and/or the presence of cannabinoids within the system of the user 12. More particularly, each controller 18, 30 and each application 16, 28 can include or incorporate one or more algorithms that enhance the functioning of the mobile system 10 for its intended purposes. For such purposes, each controller 18, 30 can include one or more processors and circuits that are specifically configured for carrying out the intended purposes of the mobile system 10.

As noted above, the cannabinoid which is the primary psychoactive compound of the cannabis plant is THC. Thus, THC may be the cannabinoid that would be of most interest for this particular application, as THC would have the greatest impact on the user's ability to operate a motor vehicle, operate heavy machinery, and effectively interact with students, patients, customers, clients, etc. Accordingly, in this particular application, the measurement device 24 can be primarily configured to collect user data related to THC levels within the blood of the users 12. Additionally, the measurement device 24 can also be configured to collect user data related to the levels of other cannabinoids within the blood of the users 12.

The memory 20 within the computing devices 14, as well as the administrative device memory 32 within the administrative computing devices 26, is intended to provide temporary storage of any relevant user data and information, as such user data and information is transmitted to and from the database 19. More particularly, in certain applications, the user 12 can input certain user data into the computing device 14, which is saved in the memory 20 of the computing device 14 prior to such user data being transmitted or uploaded to the server 15 and/or the database 19. Additionally, the memory 20 and the administrative device memory 32 can also be used to store certain relevant user data upon request that is being transmitted from the database 19 to the computing device 14 and the administrative computing device 26, respectively.

As utilized herein, the relevant “user data” can include measured information about the levels of THC, CBD and/or other cannabinoids within the blood of the user 12, and any personal data and information related to the user 12, including any and all specifics related to their personal experiences of marijuana usage.

During use of the system 10, the THC (or other cannabinoid) level information from the measurement device 24, and any information derived therefrom, is sent or otherwise transmitted from the measurement device 24 to the server 15 and/or the database 19. When the measurement device 24 is external to the computing device 14, the THC (or other cannabinoid) level information and the related information must first be sent or otherwise transmitted from the measurement device 24 to the computing device 14. This transmission can occur in various different ways. For example, the transmission of the THC (or other cannabinoid) level information and the related information from the measurement device 24 to the computing device 14 can occur by a wired connection such as a 3.5 mm aux input/‘Square card’ type reader. Alternatively, the transmission can occur by another type of wired connection. Still alternatively, the transmission of the THC (or other cannabinoid) level information and the related information from the measurement device 24 to the computing device 14 can occur wirelessly. For example, the transmission can occur via a wireless Bluetooth® connection, or any other suitable wireless connection that is compatible with the measurement device 24.

Further, in various embodiments, the user data can be saved and stored by the system 10, e.g., within the database 19, and can be shared with any of the other computing devices 14 and/or administrative computing devices 26. Thus, the user data can be saved and stored within the system 10 for history, leveraging and/or trending purposes. Additionally, as provided herein, the user data can also be forwarded to other users of the system 10 via the database 19, via app-to-app data connections, via electronic mail systems, via social media programs, or by any other suitable method. The system 10 can also store and/or forward a report via the database 19 listing the user's measurement history, which can be in a tabular format, a spreadsheet format, a graphical format, or any other suitable format. Further, in some embodiments, the system 10 can export the user data in various formats or open source.

It is appreciated that with personal information of the users 12 being saved within the database 19, it can be desired by the users 12 to protect their personal information. Stated in another manner, the simple use of the mobile system 10, e.g., via the app 16, does not automatically require the users 12 to compromise any privacy concerns that they may have regarding their personal information. In that respect, in various embodiments, it is provided that the information and data from the users 12 can be encrypted and/or password-protected such that the data and information is not readily seen by others unless the users 12 provide explicit permission to do so, e.g., to certain specific other users.

The audio/video assembly 22, 34 within any of the computing devices 14, 26A, 26B can be utilized to capture and replay any audio or video aspects of the use of the mobile system 10. For example, the audio/video assembly 22 that is incorporated within the mobile device 14 that is directly accessed by the user 12 can be configured to capture the audio and video aspects of any use of the mobile system 10 by the user, such as when the user 12 is being tested with the measurement device 24. Additionally, the audio/video assembly 34 that is incorporated within the administrative computing devices 26A, 26B can be configured to play back any audio and video recordings of such uses by the user 12, as desired by any administrative entity personnel.

Further, in certain embodiments, the system 10 can display user identification information or other user data, time and/or date of the use of the measurement device 24, the measured THC (or other cannabinoid) level, and/or any other relevant or desired information relating to the use of the system 10. In one embodiment, the system 10 can announce measurement information audibly (e.g., for vision impaired users) via an internal speaker of the computing device 14, and/or 3.5 mm audio output. Alternatively, other suitable methods of audible transmission of the user data can be utilized.

As noted herein above, the system 10, and the applications 16, 28 included therein, can be configured to function in different manners depending on the particular intended uses of the system 10. In various embodiments, the system 10 and apps 16, 28 can set limits and/or targets. For example, in some such embodiments, the system 10 and apps 16, 28 can set limits and/or targets consistent with or in accordance with laws or other regulations for driving, operation of machinery, etc. Other suitable limits and/or targets can be determined by the user or overseer, such as for medicinal purposes, or for any other suitable purpose. In some embodiments, alarms or other suitable notification methods can be used by the system 10 to provide users or overseers with visual, audible, tactile or olfactory stimuli when limits and/or targets are approached and/or achieved. In certain embodiments, the system 10 can identify the specific location of measurement of the blood THC level of the user 12 via a global positioning system function of the computing device 14.

The system 10 and apps 16, 28 can also integrate with various vehicle operation restriction devices (i.e. ignition interlock, door lock, speed reduction or thresholding, etc.), for law enforcement or other regulatory purposes. In particular, as shown in FIG. 1, the system 10 can be coupled to an operable machine 38, e.g., a motor vehicle or other type of heavy machinery. In certain embodiments, the system 10 can be coupled to an interlock system 38A that is provided within the operable machine 38. In such embodiments, if the user 12 has a THC level as measured by the measurement device 24 that is above a certain threshold level, then the interlock system 38A can be selectively locked so that the user 12 cannot operate the operable machine 38 for a predetermined period of time or until such time as the user's THC level, as measured by the measurement device 24, falls below the certain threshold level. In one embodiment, the system 10 and apps 16, 28 can include one or more algorithms that can estimate the time until the user's THC level reaches a specified level (i.e. return to under the legal limit, or rise above a particular threshold, for example). In certain embodiments, if the THC data so indicates, the system 10 and apps 16, 28 can allow the user to request or otherwise contact a transportation service from the mobile device 14, or the system 10 and apps 16, 28 can automatically do so.

In some embodiments, the system 10 and apps 16, 28 can require the user 12 to use the system 10 (and/or measurement device 24) at regular predetermined intervals, or randomly as determined by the system 10 and apps 16, 28, or at any other suitable time or time period. The system 10 and apps 16, 28 can also include an alarm (audible, visual, vibration, email, and phone/text) to notify the user when they are scheduled and/or required to use the system 10 and/or measurement device 24. The system 10 and apps 16, 28 can further include the ability to notify another user (or external party) that the user 12 did not use the system 10 and/or measurement device 24 when required to do so.

Additionally, in certain embodiments, the system 10 and app 16 can also include a social media integration and/or posting feature so that the user data can be posted either manually or automatically on various social media programs.

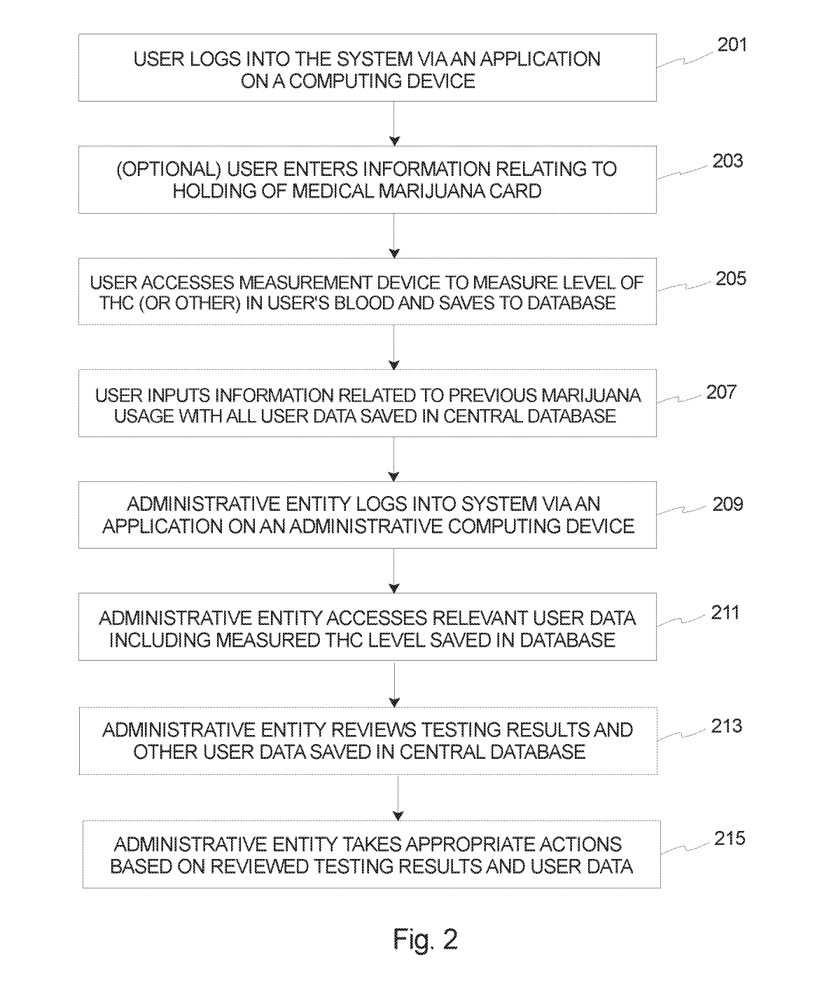

FIG. 2 is a flowchart that illustrates a representative example of the general operation of the mobile system illustrated in FIG. 1. In particular, in this embodiment, the mobile system is being effectively overseen by an administrative entity, e.g., law enforcement, human resources department, etc.

At step 201, the user accesses the application on a computing device, e.g., a mobile computing device, and logs into the system. The user can access the application via any suitable computing device, such as a smartphone, laptop, tablet, smart watch, desktop computer, or other suitable computing device. Additionally, the user can log into the system through use of a special user ID and password, or via social media account (e.g., Facebook or Twitter).

At step 203, the user optionally enters information relating to whether or not they hold a state-issued medical marijuana card.

At step 205, the user accesses a measurement device to measure the level of THC (and/or other cannabinoids) that are present in the user's blood. In different embodiments, the measurement device can be accessed internally to the computing device, or the measurement device can be accessed externally from the computing device. Additionally, the measurement device can be configured to effectively measure the level of THC (or other) in the user's blood in any suitable manner. For example, in certain non-exclusive alternative embodiments, the measurement device can be configured to measure the THC levels via the user's breath, perspiration, saliva, mucous membrane swabbing, blood, urine, or skin (transdermal). In some such embodiments, the measurement device can be configured to provide continuous or ongoing testing for THC (or other) levels, e.g., via skin patch, wearable device, etc. Alternatively, the measurement device can be configured to measure the THC levels in any other suitable manner.

Further, the testing experience may be captured in audio and/or video form by the audio/video assembly that may be included within the computing device. Still further, the testing results, as well as the date, time and place of the testing experience, may be transmitted to a server and saved in a database.

It is appreciated that the testing experience may be conducted based on a specific testing schedule for the user as established by the appropriate administrative entity, or the testing experience may be conducted on an on-demand or ad hoc basis.

At step 207, the user can input information and data related to previous usages of marijuana. Such information and data can be in the form of typical user usage, e.g., typical weekly usage, and/or the information and data can be in the form of recent specific usages. It is appreciated that this step is optional, and may or may not be specifically required by the administrative entity depending on the particular relationship between the administrative entity and the user. When inputted by the user, such additional user data can also transmitted to the server and saved in the database.

At step 209, the administrative entity logs onto the system by accessing an administrative application that has been installed or downloaded within an administrative computing device. More specifically, the administrative function can access the system via a mobile computing device and/or a desktop computing device.

At step 211, the user data including the results, i.e. the THC levels, and any other relevant user data are accessed upon request by the appropriate administrative entity via the administrative application. More specifically, the relevant user data, including the testing results, can be transmitted from the database to the administrative computing device such that the relevant user data is now accessible by the administrative entity.

At step 213, the administrative entity reviews the specific testing results from the user (and any other relevant user data) that have been saved in the database.

At step 215, the administrative entity takes any and all appropriate actions based on the information reviewed in step 213. For example, if the administrative function is law enforcement, the law enforcement can decide whether or not to take the user into custody, whether or not to prevent the user from operating a motor vehicle, or another suitable action. Alternatively, if the administrative function is a human resources department, the human resources department can decide whether or not to prevent the user from operating certain machinery in their present condition, whether or not to prevent the user from interacting with customers, clients or patients, or another suitable action. Still alternatively, if the administrative function is an educational function, the educational function can decide whether or not to prevent the user from participating in the learning experience (either as an educator or a student) in their present condition, or another suitable action.

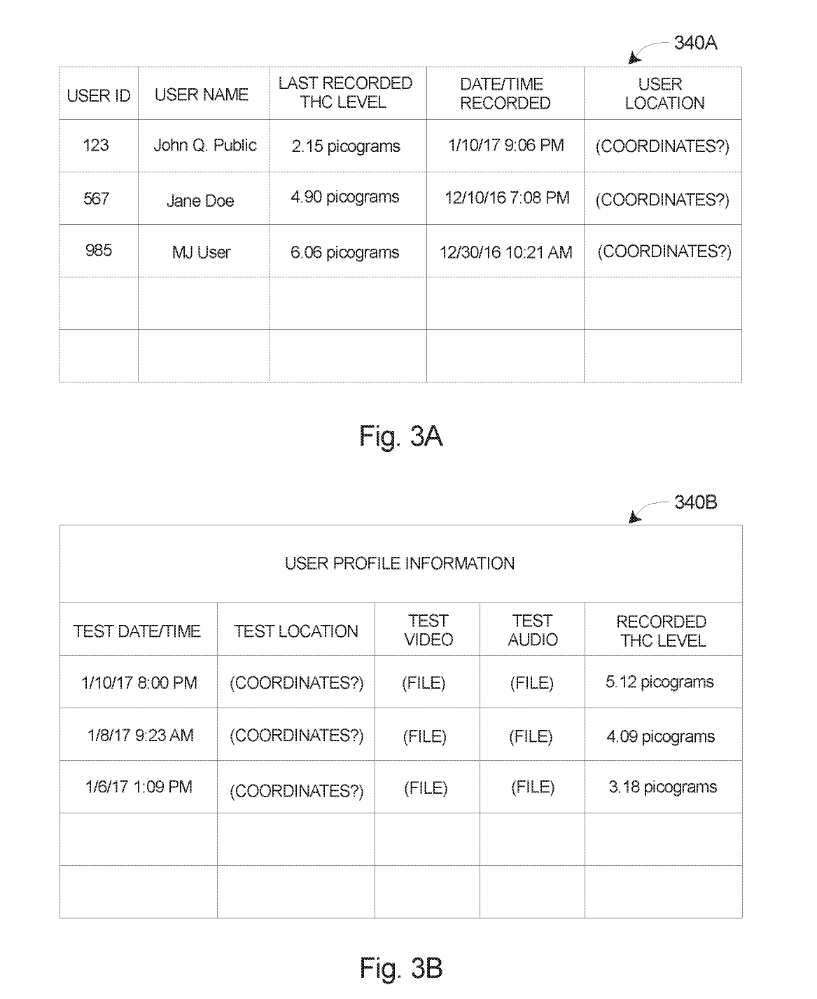

FIG. 3A is a simplified illustration of a sample output from a database, i.e. a first database report 340A, that can be utilized within the mobile system 10 illustrated in FIG. 1. In particular, FIG. 3A illustrates the first database report 340A that shows testing results from three distinct users in a recent time frame. As shown, the first database report 340A can include such information as user id number, user name, last recorded THC level, date and time of when the THC level was recorded, and a user location when the user was tested. Additionally and/or alternatively, the first database report 340A can include more or less information than the specific examples noted above.

FIG. 3B is another simplified illustration of a sample output from the database, i.e. a second database report 340B. More specifically, FIG. 3B illustrates the second database report 340B that shows testing results from multiple testing experiences with the same user. Depending on the specific application, such testing results may be visible to the appropriate administrative entity, the specific user, or both. As shown, the second database report 340B can include such information as user profile information, dates and times of recent THC level testing experiences for the user, user locations when the user was tested, video and audio files related to the specific testing experiences, and recorded THC levels for the user from the specific testing experiences. Additionally and/or alternatively, the second database report 340B can include more or less information than the specific examples noted above.

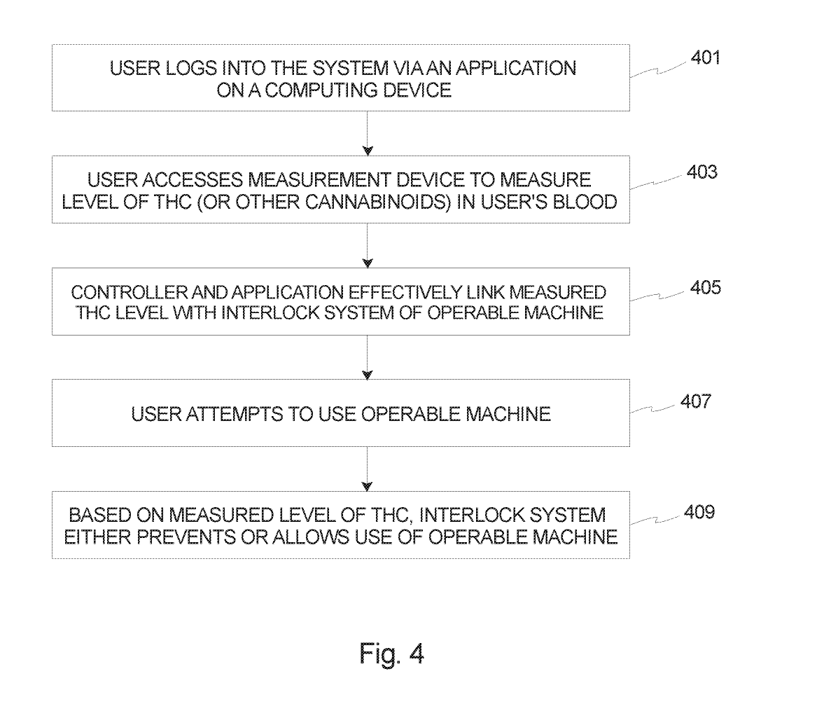

FIG. 4 is a flowchart that illustrates another representative example of the general operation of the mobile system illustrated in FIG. 1. In particular, FIG. 4 is a flowchart that illustrates the general operation of the system relating to potential machine interlock systems.

At step 401, the user accesses the application on a computing device, e.g., a mobile computing device, and logs into the system.

At step 403, the user accesses a measurement device to measure the level of THC (and/or other cannabinoids) that is present in the user's blood. In different embodiments, the measurement device can be accessed internally to the computing device, or the measurement device can be accessed externally from the computing device. Additionally, the measurement device can be configured to effectively measure the level of THC (or other) in the user's blood in any suitable manner. For example, in certain non-exclusive alternative embodiments, the measurement device can be configured to measure the THC levels via the user's breath, perspiration, saliva, mucous membrane swabbing, blood, urine, or skin (transdermal). Alternatively, the measurement device can be configured to measure the THC levels in any other suitable manner.

In this particular application, it is appreciated that, as provided herein, the user may be required to use the system by an appropriate administrative entity prior to using any operable machine, or at any other predetermined times.

At step 405, the controller and/or application within the computing device can effectively link the results of the user's THC level as measured by the measurement device with the appropriate operable machine, e.g., the motor vehicle to be driven by the user, or the piece of heavy machinery to be operated by the user. More specifically, the controller and/or application can be linked to an interlock system of the operable machine.

At step 407, the user can attempt to use the appropriate operable machine. At step 409, based on the specific results from the measurement device, the interlock system that is built into the operable machine can either prevent the user from using the operable machine or allow the user to operate the operable machine. It is appreciated that the interlock system can be designed in any suitable manner for purposes of preventing the user from using the operable machine under certain such conditions. Additionally, in certain embodiments, the interlock system can prevent such use for a predetermined period of time, or until such time as the user's measured THC level falls below a specified threshold level.

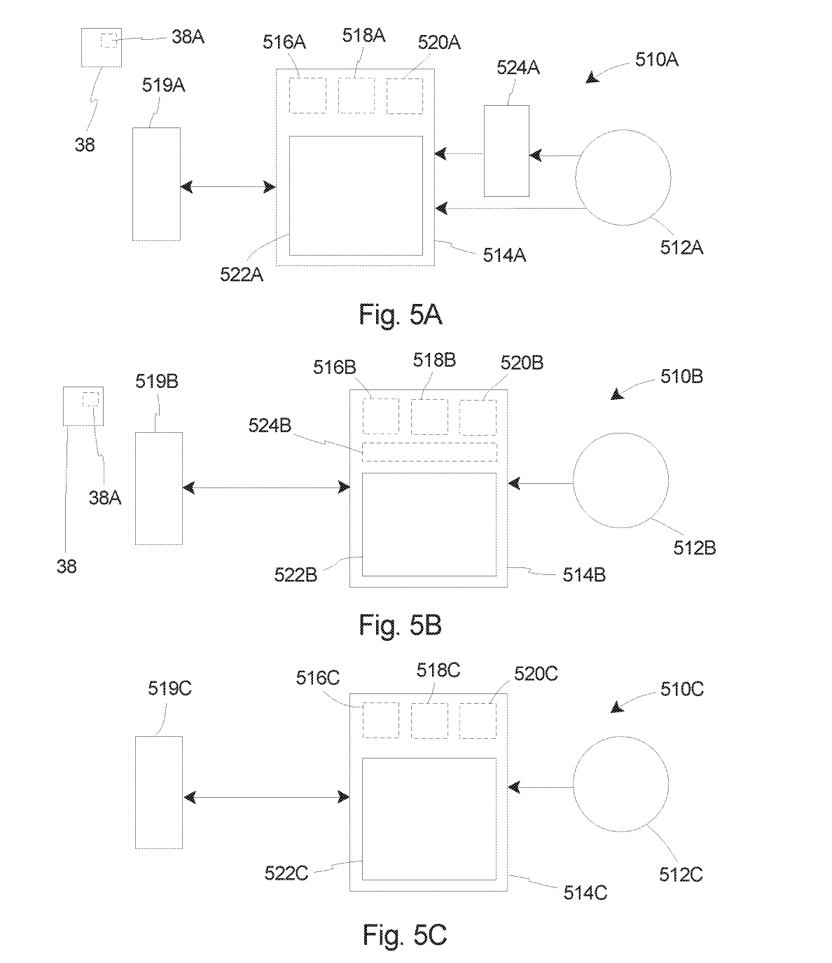

FIGS. 5A-5C are simplified schematic illustrations of additional embodiments of the mobile system. As illustrated herein, these embodiments have various features and components in common with the embodiment of the mobile system 10 illustrated and described above in relation to FIG. 1, with the exception of not including any aspects of the administrative computing device as used by the administrative entities. Thus, more specifically, FIGS. 5A-5C each illustrate embodiments of the mobile system that are most appropriately used by recreational marijuana users and/or medical marijuana users.

FIG. 5A is a simplified schematic illustration of another embodiment of the mobile system 510A. Similar to the above embodiments, as shown in FIG. 5A, the mobile system 510A includes a computing device 514A, e.g., a mobile computing device or a desktop computing device, that is accessible by at least one user 512A, with the computing device 514A including a device application 516A (illustrated in phantom), a controller 518A (illustrated in phantom), a memory 520A (illustrated in phantom) and an audio/video assembly 522A. Additionally, the mobile system 510A further incorporates the use of a measurement device 524A that is provided independently from the computing device 514A. Further, as shown, the system 510A also includes a database 519A to which relevant user data can be transmitted and/or uploaded for purposes of receiving, compiling and storing such relevant user data from multiple users.

As above, the device application 516A can be utilized in conjunction with the controller 518A to effectively control the collection, compiling, storage and leveraging of any and all user data and information related to the use of marijuana by the at least one user 512A. More particularly, the device application 516A and the controller 518A can include or incorporate one or more algorithms that enhance the functioning of the mobile system 510A for its intended purposes.

Additionally, as with the previous embodiments, the database 519A is configured to receive, compile and store any relevant user data that may be transmitted to or generated within the computing device 514A. For example, the measurement device 524A may be accessed by the user 512A for purposes of measuring the level of THC, CBD and/or other cannabinoids in the blood of the user 512A in any suitable manner. Subsequently, the measured levels of cannabinoids in the blood of the user 512A can be transmitted to the computing device 514A, i.e. by any suitable wireless or wired connection. Subsequently, such measured levels of cannabinoids in the blood of the user 512A can be transmitted to and stored within the database 519A. Further, additional user data in the form of unique user inputs related to the specific subjective marijuana use and experience of the user 512A can also be transmitted by the user 512A into the computing device 514A, e.g., via the application 516A, and subsequently transmitted to and stored in the database 519A. It is appreciated that any and all user data that has been stored within the database 519A can be shared as desired with any other users of the system 510A.

The audio/video assembly 522A can again be utilized to capture and replay any audio or video aspects of the use of the system 510A by the user 512A, such as when the user 512A is being tested with the measurement device 524A.

Further, the system 510A and application 516A can also be coupled to an interlock system 38A of an operable machine 38 for purposes of advising the user 512A and controlling the activities of the user 512A regarding whether or not it is safe to operate the operable machine 38 in their current condition.

FIG. 5B is a simplified schematic illustration of still another embodiment of the mobile system 510B. As shown in FIG. 5B, the mobile system 510B includes a computing device 514B, e.g., a mobile computing device or a desktop computing device, that is accessible by at least one user 512B, with the computing device 514B including a device application 516B (illustrated in phantom), a controller 518B (illustrated in phantom), a memory 520B (illustrated in phantom), an audio/video assembly 522B, and a measurement device 524B. Additionally, as shown, the system 510B can also include a database 519B to which relevant user data can be transmitted and/or uploaded for purposes of receiving, compiling and storing such relevant user data from multiple users.

The various features and components of the mobile system 510B are substantially similar in design and operation to the features and components of the mobile system 510A illustrated in FIG. 5A, with the exception that in this embodiment, the measurement device 524B is housed, embedded and/or encompassed within the computing device 514B, i.e. is not provided independently from the computing device 514B. Accordingly, the specific design and functionality of such features and components will not be repeated in detail herein.

Further, the system 510B and application 516B can again be coupled to an interlock system 38A of an operable machine 38 for purposes of advising the user 512B and controlling the activities of the user 512B regarding whether or not it is safe to operate the operable machine 38 in their current condition.

FIG. 5C is a simplified schematic illustration of yet another embodiment of the mobile system 510C. As illustrated in FIG. 5C, the mobile system 510C is somewhat similar to the mobile systems 510A, 510B illustrated and described in relation to FIG. 5A and FIG. 5B, respectively. For example, as shown, the mobile system 510C again includes a computing device 514C, e.g., a mobile computing device or a desktop computing device, that is accessible by at least one user 512C, with the computing device 514C including a device application 516C (illustrated in phantom), a controller 518C (illustrated in phantom), a memory 520C (illustrated in phantom), and an audio/video assembly 522C. Additionally, as shown, the system 510C can also include a database 519C to which relevant user data can be transmitted and/or uploaded for purposes of receiving, compiling and storing such relevant user data from multiple users.

However, in this embodiment, the mobile system 510C is designed without a measurement device for measuring the levels of various cannabinoids in the blood of the user 512C. As such, the user data that is transmitted into the computing device 514C, i.e. via the application 516C, and stored within the database 519C is solely the subjective user data in the form of unique user inputs related to the specific subjective marijuana use and experience of the user 512C. The subjective information from the user 512C can be input via a “manual” mode that can be provided within the system 510C or application 516C.

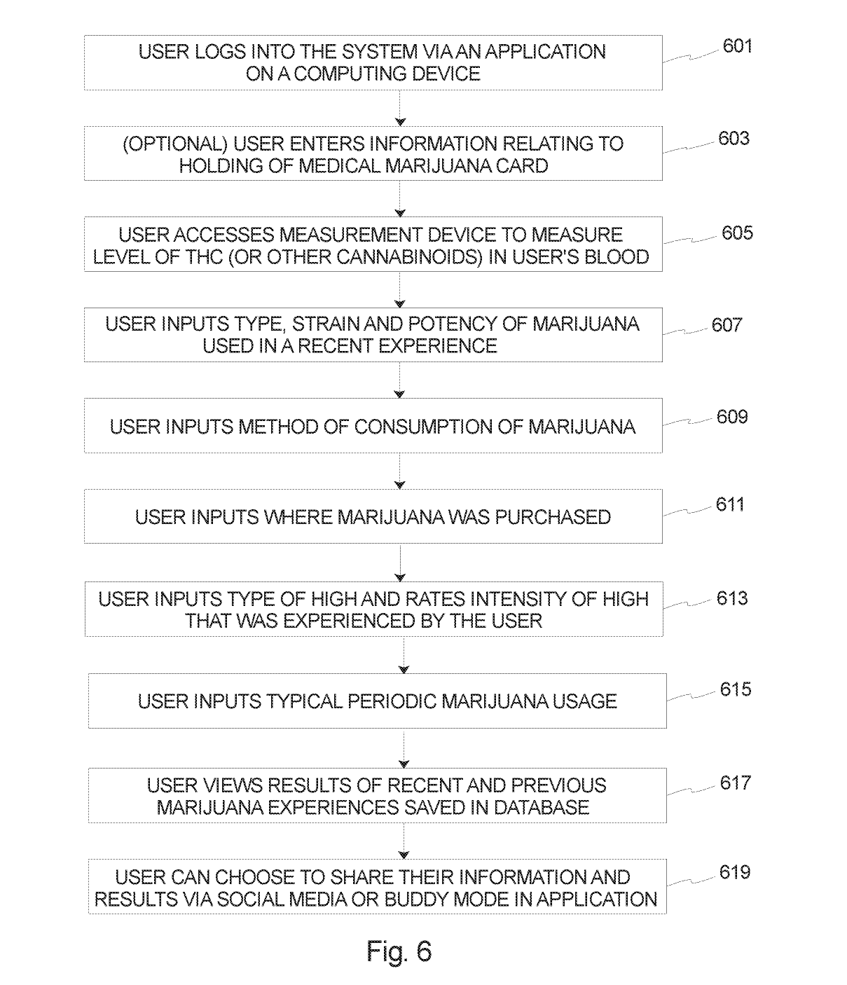

FIG. 6 is a flowchart that illustrates a representative example of the general operation of the mobile system illustrated in FIG. 5A or FIG. 5B. In particular, this example relates to the use of the mobile system by a recreational marijuana user. Additionally, this example relates to the user providing both an objective and subjective reporting of their particular marijuana experience.

At step 601, the user accesses the application on a computing device, e.g., a mobile computing device, and logs into the system.

At step 603, the user optionally enters information relating to whether or not they hold a state-issued medical marijuana card.

At step 605, the user accesses a measurement device to measure the level of THC and CBD (and/or other cannabinoids) that is present in the user's blood. In different embodiments, the measurement device can be accessed internally to the computing device, or the measurement device can be accessed externally from the computing device. Additionally, the measurement device can be configured to effectively measure the level of THC and CBD (or other) in the user's blood in any suitable manner. For example, in certain non-exclusive alternative embodiments, the measurement device can be configured to measure the THC and CBD levels via the user's breath, perspiration, saliva, mucous membrane swabbing, blood, urine, or skin (transdermal). Alternatively, the measurement device can be configured to measure the THC and CBD levels in any other suitable manner.

As noted herein above, THC is the cannabinoid primarily associated with the “high” feeling that can be experienced by the recreational marijuana user. Accordingly, in this example, the measurement device can be used primarily for purposes of measuring the level of THC in the blood of the user.

Further, as with the previous embodiments, the testing experience may be captured in audio and/or video form by the audio/video function of the computing device. Still further, the testing results may be saved in a database internal or external to the computing device.

At step 607, the user inputs the type, strain and potency of the marijuana the user has used in a recent experience. This and all other user inputs may also be transmitted together with the testing information noted above to a server and saved in a central database.

At step 609, the user inputs the method of consumption of the marijuana. For example, the user can specify that the marijuana has been consumed by smoking the marijuana (e.g., pipe, bong, or marijuana cigarette/joint), vaping the marijuana (e.g., with use of a vape pen), or in edible (or other consumable) form.

At step 611, the user inputs where the marijuana was purchased, i.e. the general location or specific dispensary, as non-exclusive examples.

At step 613, the user inputs the type and intensity of the high that was experienced by the user based on the specific consumption of the marijuana noted above. For example, the user can input certain information regarding how they feel or felt after consuming the marijuana, and the user can rate intensity along a continuum from a low intensity to a high intensity.

At step 615, the user can optionally input their typical marijuana usage, e.g., how much marijuana the user typically consumes on a weekly basis (e.g., “hits” or grams), or in any given episode of marijuana usage.

At step 617, the user can view the results that have been saved in the database based on this present use of marijuana, as well as any previous uses of marijuana that have previously been saved within the system or database.

At step 619, the user can choose to share their information and results in any suitable manner. For example, the user can choose to share their results via any suitable social media account. Additionally, in some embodiments, the application can include a secondary user (or buddy) mode, where the user can choose to allow specific others to access their information and results.

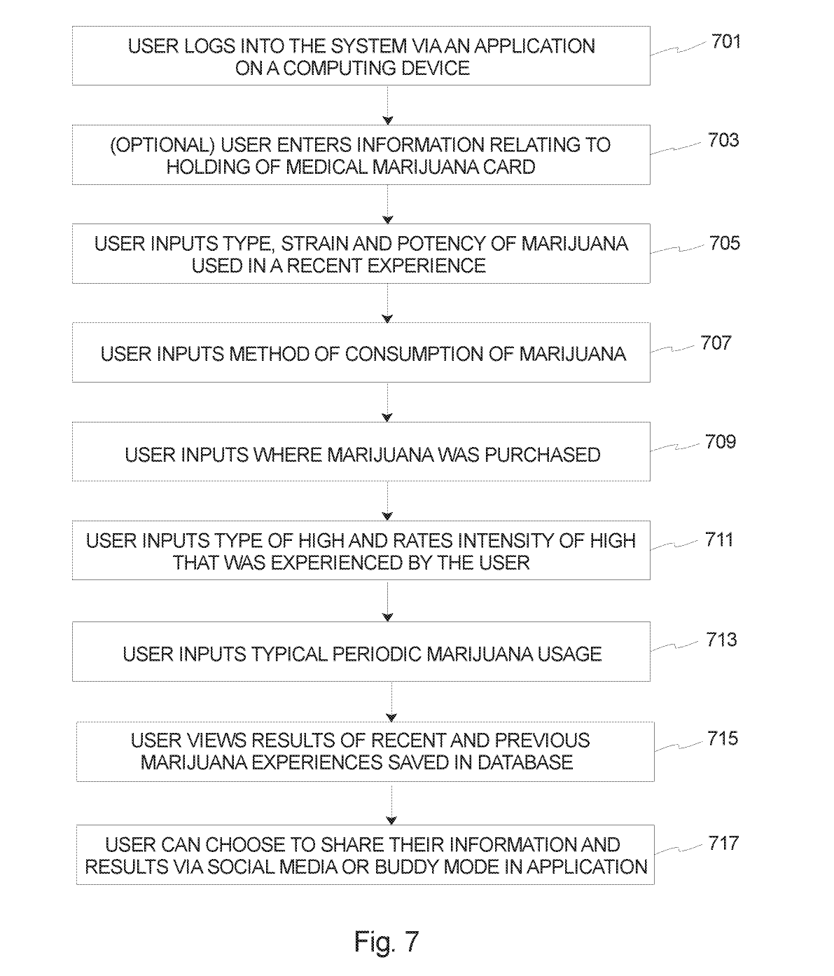

FIG. 7 is a flowchart that illustrates a representative example of the general operation of the mobile system illustrated in FIG. 5C. In particular, this example again relates to the use of the mobile system by a recreational marijuana user, but without the corresponding usage of a measurement device. Stated in another manner, this example relates to the user simply reporting their subjective marijuana experience.

At step 701, the user accesses the application on a computing device, e.g., a mobile computing device, and logs into the system.

At step 703, the user optionally enters information relating to whether or not they hold a state-issued medical marijuana card.

At step 705, the user inputs the type, strain and potency of the marijuana the user has used in a recent experience. This and all other user inputs may be transmitted to a server and saved in a central database.

At step 707, the user inputs the method of consumption of the marijuana. For example, the user can specify that the marijuana has been consumed by smoking the marijuana (e.g., pipe, bong, or marijuana cigarette/joint), vaping the marijuana (e.g., with use of a vape pen), or in consumable form.

At step 709, the user inputs where the marijuana was purchased, i.e. the general location or specific dispensary, as non-exclusive examples.

At step 711, the user inputs the type and intensity of the high that was experienced by the user based on the specific consumption of the marijuana noted above. For example, the user can input certain information regarding how they feel or felt after consuming the marijuana, and the user can rate intensity along a continuum from a low intensity to a high intensity.

At step 713, the user can optionally input their typical marijuana usage, e.g., how much marijuana the user typically consumes on a weekly basis, or in any given episode of marijuana usage.

At step 715, the user can view the results that have been saved in the database based on this present use of marijuana, as well as any previous uses of marijuana that have previously been saved within the system or database.

At step 717, the user can choose to share their information and results in any suitable manner. For example, the user can choose to share their results via any suitable social media account. Additionally, in some embodiments, the application can include a secondary user (or buddy) mode, where the user can choose to allow specific others to access their information and results.

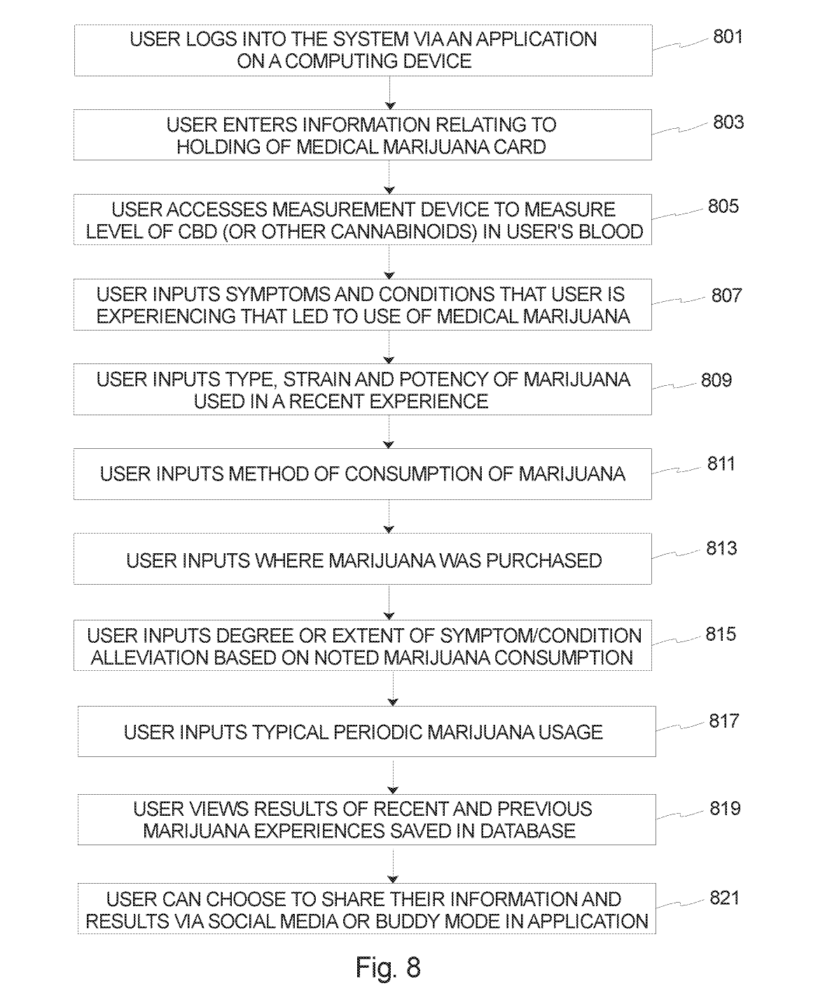

FIG. 8 is a flowchart that illustrates another representative example of the general operation of the mobile system illustrated in FIG. 5A or FIG. 5B. In particular, this example relates to the use of the mobile system by a medical marijuana user. Additionally, this example relates to the user providing both an objective and subjective reporting of their particular marijuana experience.

At step 801, the user accesses the application on a computing device, e.g., a mobile computing device, and logs into the system.

At step 803, the user optionally enters information relating to whether or not they hold a state-issued medical marijuana card.

At step 805, the user accesses a measurement device to measure the level of CBD and THC (and/or other cannabinoids) that is present in the user's blood. In different embodiments, the measurement device can be accessed internally to the computing device, or the measurement device can be accessed externally from the computing device. Additionally, the measurement device can be configured to effectively measure the level of CBD and THC (or other) in the user's blood in any suitable manner. For example, in certain non-exclusive alternative embodiments, the measurement device can be configured to measure the CBD and THC levels via the user's breath, perspiration, saliva, mucous membrane swabbing, blood, urine, or skin (transdermal). Alternatively, the measurement device can be configured to measure the CBD and THC levels in any other suitable manner.

As noted herein above, CBD is generally recognized as the cannabinoid responsible for many medicinal and therapeutic properties associated with medical marijuana. Accordingly, in this example, the measurement device can be used primarily for purposes of measuring the level of CBD in the blood of the user.

Further, the testing experience may again be captured in audio and/or video form by the audio/video function of the computing device. Still further, the testing results may be saved in a database internal or external to the computing device.

At step 807, the user inputs the specific symptoms and conditions that the user is experiencing that led the user to the use of medical marijuana. This and all other user inputs may also be transmitted together with the testing information noted above to a server and saved in a central database.

It is appreciated that the specific symptoms and conditions can be any appropriate symptoms and conditions. For example, a non-exclusive list of potential symptoms includes acute pain, antisocial behaviors, back pain, cachexia/Wasting Syndrome, cancer pain, chemotherapy side effects, chronic pain, convulsions/seizures, dental/mouth pain, digestive issues, eye pain, fatigue, flashbacks, gastrointestinal (GI) pain, headache/migraine, inflammation, insomnia, joint pain, loss of appetite, menstrual pain, motion sickness, muscle spasm, muscle tension, nausea/vomiting (e.g., chemotherapy-induced), neuropathy/neuropathic pain, nightmares, pain, panic attack, post-amputation pain, restlessness, stress, tremors, and weight loss.

Additionally, a non-exclusive list of conditions includes acne, ADD/ADHD, addiction, AIDS, amyotrophic lateral sclerosis (ALS), Alzheimer's Disease, anorexia, antibiotic resistance, anxiety, atherosclerosis, arthritis, asthma, autism, bipolar, cancer, Crohn's Disease, dementia, depression, diabetes, digestive issues, dystonia, endocrine disorders, epilepsy and seizures, fibromyalgia, glaucoma, heart disease, HIV, Huntington's Disease, inflammation, irritable bowel syndrome, kidney disease, liver disease, Metabolic Syndrome, migraine, mood disorders, motion sickness, multiple sclerosis, nausea, neurodegeneration, obesity, OCD, osteoporosis/bone health, Parkinson's Disease, Prion/Mad Cow Disease, Post-Traumatic Stress Disorder (PTSD), rheumatoid arthritis, schizophrenia, Sickle Cell Anemia, skin conditions, sleep disorders, spasticity, spinal cord injury, stress, stroke, tendonitis, tinnitus, Tourette's Syndrome, traumatic brain injury (TBI), Trigeminal Neuralgia, and Ulcerative Colitis.

At step 809, the user inputs the type, strain and potency of the marijuana the user has used in a recent experience.

At step 811, the user inputs the method of consumption of the marijuana. For example, the user can specify that the marijuana has been consumed by smoking the marijuana (e.g., pipe, bong, or marijuana cigarette/joint), vaping the marijuana (e.g., with use of a vape pen), or in consumable form.

At step 813, the user inputs where the marijuana was purchased, i.e. the general location or specific dispensary, as non-exclusive examples.

At step 815, the user inputs the degree or extent of symptom and condition alleviation that the user experienced based on the noted consumption of marijuana.

At step 817, the user can optionally input their typical marijuana usage, e.g., how much marijuana the user typically consumes on a weekly basis, or in any given episode of marijuana usage.

At step 819, the user can view the results that have been saved in the database based on this present use of marijuana, as well as any previous uses of marijuana that have previously been saved within the system or database.

At step 821, the user can choose to share their information and results in any suitable manner. For example, the user can choose to share their results via any suitable social media account. Additionally, in some embodiments, the application can include a secondary user (or buddy) mode, where the user can choose to allow specific others to access their information and results.

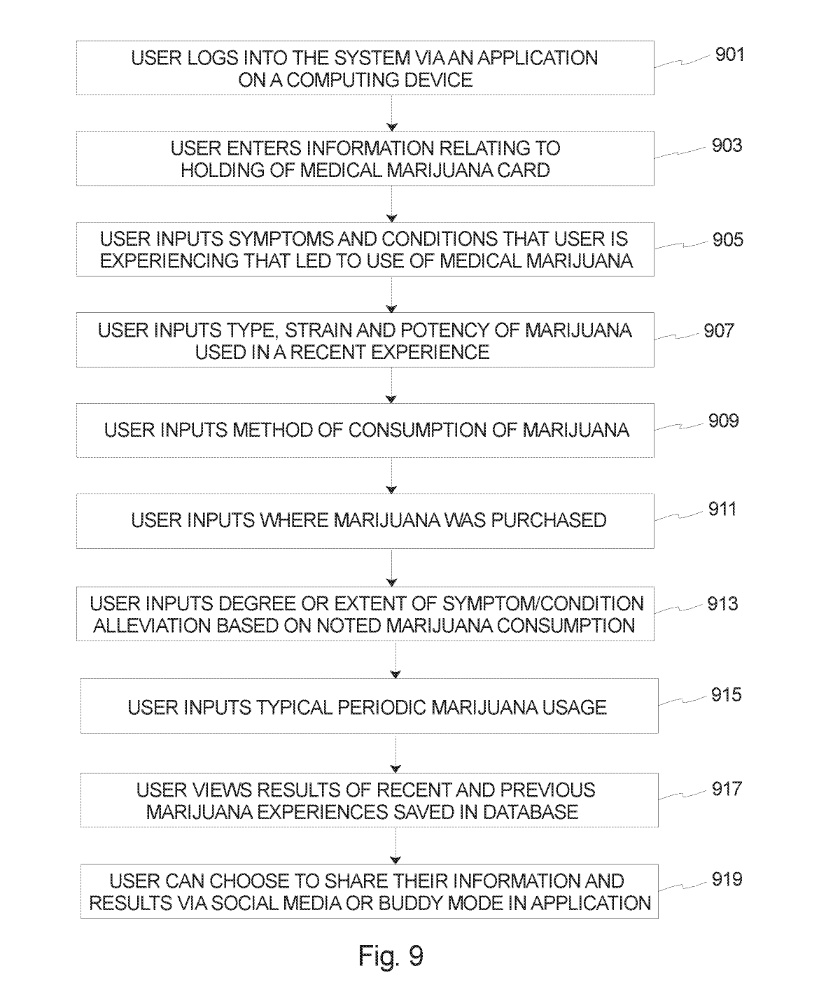

FIG. 9 is a flowchart that illustrates another representative example of the general operation of the mobile system illustrated in FIG. 5C. In particular, this example again relates to the use of the mobile system by a medical marijuana user, but without the corresponding usage of a measurement device. Stated in another manner, this example relates to the user simply reporting their subjective marijuana experience.

At step 901, the user accesses the application on a computing device, e.g., a mobile computing device, and logs into the system.

At step 903, the user optionally enters information relating to whether or not they hold a state-issued medical marijuana card.

At step 905, the user inputs the specific symptoms and conditions that the user is experiencing that led the user to the use of medical marijuana. This and all other user inputs may be transmitted to a server and saved in a central database. It is appreciated that the specific symptoms and conditions can be any appropriate symptoms and conditions, such as noted above.

At step 907, the user inputs the type, strain and potency of the marijuana the user has used in a recent experience.

At step 909, the user inputs the method of consumption of the marijuana. For example, the user can specify that the marijuana has been consumed by smoking the marijuana (e.g., pipe, bong, or marijuana cigarette/joint), vaping the marijuana (e.g., with use of a vape pen), or in consumable form.

At step 911, the user inputs where the marijuana was purchased, i.e. the general location or specific dispensary, as non-exclusive examples.

At step 913, the user inputs the degree or extent of symptom and condition alleviation that the user experienced based on the noted consumption of marijuana.

At step 915, the user can optionally input their typical marijuana usage, e.g., how much marijuana the user typically consumes on a weekly basis, or in any given episode of marijuana usage.

At step 917, the user can view the results that have been saved in the database based on this present use of marijuana, as well as any previous uses of marijuana that have previously been saved within the system or database.

At step 919, the user can choose to share their information and results in any suitable manner. For example, the user can choose to share their results via any suitable social media account. Additionally, in some embodiments, the application can include a secondary user (or buddy) mode, where the user can choose to allow specific others to access their information and results.

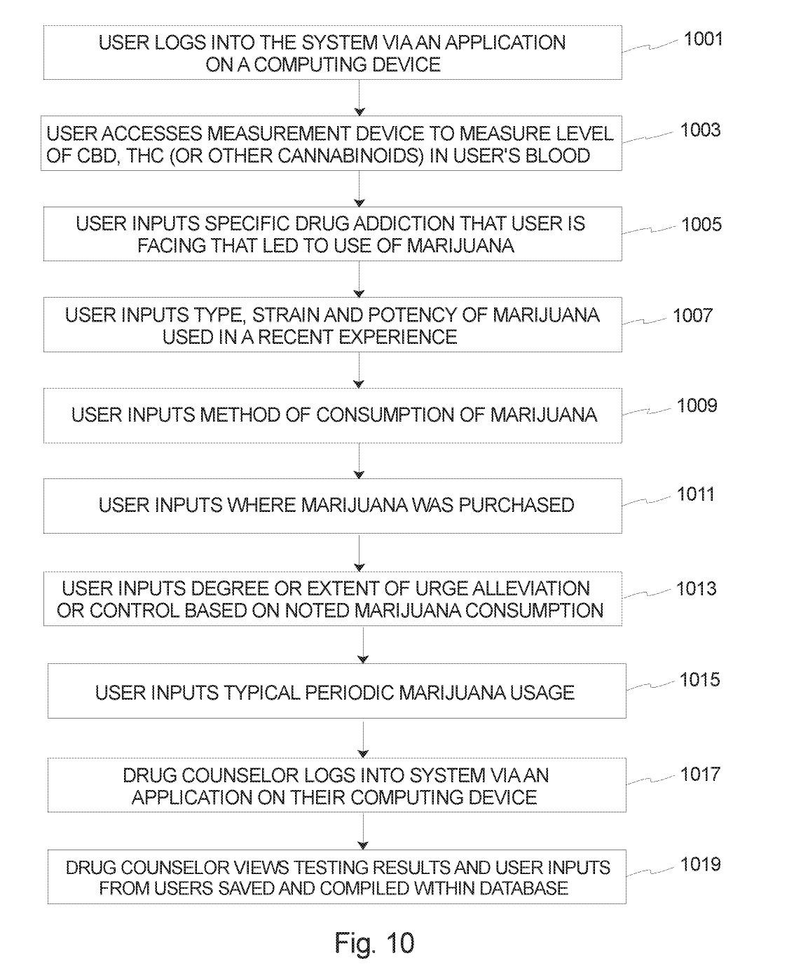

FIG. 10 is a flowchart that illustrates still another representative example of the general operation of the mobile system. In particular, this example relates to the use of the mobile system for purposes of treatment and monitoring of drug addicts. This example relates to both an objective and subjective reporting of the particular marijuana experience of known drug addicts that can subsequently be compiled for research purposes and for future treatment of any drug addicts.

At step 1001, the user accesses the application on a computing device, e.g., a mobile computing device, and logs into the system.

At step 1003, the user accesses a measurement device to measure the level of CBD and THC (and/or other cannabinoids) that is present in the user's blood. As with the previous embodiments, the measurement device can be configured to effectively measure the level of CBD and THC (or other) in the user's blood in any suitable manner.

Additionally, since this embodiment may be used by drug counselors for purposes of evaluating marijuana for purposes of alleviating symptoms (urges) of drug addiction, the use of the measurement device may be dictated by the drug counselors.

At step 1005, the user inputs the specific drug addiction, e.g., heroin, methamphetamines, cocaine, crystal meth, etc., that the user is facing that led the user to try to control their addiction through the use of marijuana. This and all other user inputs may also be transmitted together with the testing information noted above to a server and saved in a central database.

At step 1007, the user inputs the type, strain and potency of the marijuana the user has used in a recent experience. Since this embodiment may be used for purposes of research by the drug counselors, it is appreciated that in many instances, the type, strain and potency of the marijuana may again be dictated or controlled by the drug counselors.

At step 1009, the user inputs the method of consumption of the marijuana. For example, the user can specify that the marijuana has been consumed by smoking the marijuana (e.g., pipe, bong, or marijuana cigarette/joint), vaping the marijuana (e.g., with use of a vape pen), or in consumable form.

At step 1011, the user inputs where the marijuana was purchased, i.e. the general location or specific dispensary, as non-exclusive examples.

At step 1013, the user inputs the degree or extent of urge alleviation or control that the user experienced based on the noted consumption of marijuana.

At step 1015, the user can optionally input their typical marijuana usage, e.g., how much marijuana the user typically consumes on a weekly basis, or in any given episode of marijuana usage.

At step 1017, the drug counselor logs onto the system by accessing an application that has been installed or downloaded within their computing device.

At step 1019, the drug counselor reviews the specific testing results and user inputs from the users that have been saved and compiled in the database. Such results can then be leveraged by the drug counselors for determining what types, strains and potencies of marijuana may be best suited for future treatment of drug addicts.

Within all of the various flowcharts illustrated and described herein, it is recognized that the various steps described herein can be modified as necessary in the process of utilizing the system. Additionally, it is also recognized that in certain applications the order of the steps can be modified, certain steps can be omitted, certain steps can be combined, and/or additional steps can be added without limiting the intended scope and breadth of the present invention.

It is understood that although a number of different embodiments of systems and methods for monitoring and/or leveraging cannabinoid levels in the blood of a user have been described herein, one or more features of any one embodiment can be combined with one or more features of one or more of the other embodiments, provided that such combination satisfies the intent of the present invention.

While a number of exemplary aspects and embodiments of systems and methods for monitoring and/or leveraging cannabinoid levels in the blood of a user have been shown and/or disclosed herein above, those of skill in the art will recognize certain modifications, permutations, additions and sub-combinations thereof. It is therefore intended that the system and method shall be interpreted to include all such modifications, permutations, additions and sub-combinations as are within their true spirit and scope, and no limitations are intended to the details of construction or design herein shown.

What is claimed is:

1. A system for leveraging user data of a user based on a presence of at least one cannabinoid in the blood of the user, the system comprising:
a database that is configured to store the user data;
a device application that is adapted for use on a computing device, the device application being accessible by the user, the device application being configured to (i) receive the user data of the user based on the presence of the at least one cannabinoid in the blood of the user, and (ii) upload the user data to the database; and
a controller including a processor that is configured to control operation of the device application.

2. The system of claim 1 wherein the user data includes subjective information as provided by the user, the subjective information including at least one of (i) a type, strain and potency of marijuana consumed by the user, (ii) a method of consumption of the marijuana consumed by the user, and (iii) a location of purchase of the marijuana consumed by the user.

3. The system of claim 2 wherein the at least one cannabinoid in the blood of the user includes tetrahydrocannabinol, and wherein the subjective information further includes a subjective evaluation of a type and intensity of high experienced by the user based on the presence of the tetrahydrocannabinol in the blood of the user.

4. The system of claim 2 wherein the at least one cannabinoid in the blood of the user includes cannabidiol, and wherein the subjective information further includes a subjective evaluation of a degree or extent of symptom and condition alleviation for the user based on the presence of the cannabidiol in the blood of the user.

5. The system of claim 1 wherein the user data includes objective information relating to a measurement of a level of the at least one cannabinoid in the blood of the user.

6. The system of claim 5 further comprising a measurement device that is configured to measure the level of the at least one cannabinoid in the blood of the user.

7. The system of claim 6 wherein the measurement device is embedded within the computing device.

8. The system of claim 6 wherein the measurement device is provided externally from the computing device.

9. The system of claim 5 wherein the user data further includes subjective information as provided by the user, the subjective information including at least one of (i) a type, strain and potency of marijuana consumed by the user, (ii) a method of consumption of the marijuana consumed by the user, and (iii) a location of purchase of the marijuana consumed by the user.

10. The system of claim 5 further comprising an administrative device application that is provided within an administrative computing device and that is accessible by an administrative entity, the administrative device application providing the administrative entity with access to the user data stored within the database.

11. A method for leveraging user data of a user based on a presence of at least one cannabinoid in the blood of the user, the method comprising the steps of:
receiving the user data of the user based on the presence of the at least one cannabinoid in the blood of the user within a device application that is adapted for use on a computing device and that is accessible by the user;
uploading the user data to a database with the device application;
storing the user data within the database; and
controlling the operation of the device application with a controller including a processor.

12. The method of claim 11 wherein the step of receiving includes the user data including subjective information as provided by the user, the subjective information including at least one of (i) a type, strain and potency of marijuana consumed by the user, (ii) a method of consumption of the marijuana consumed by the user, and (iii) a location of purchase of the marijuana consumed by the user.

13. The method of claim 12 wherein the at least one cannabinoid in the blood of the user includes tetrahydrocannabinol, and wherein the step of receiving further includes the subjective information also including a subjective evaluation of a type and intensity of high experienced by the user based on the presence of the tetrahydrocannabinol in the blood of the user.

14. The method of claim 11 wherein the step of receiving includes the user data including objective information relating to a measurement of a level of at least one cannabinoid in the blood of the user based on the consumption of marijuana by the user.

15. The method of claim 11 further comprising the step of measuring a level of the at least one cannabinoid in the blood of the user with a measurement device, and wherein the step of receiving includes the user data including objective information relating to the measurement of the level of the at least one cannabinoid in the blood of the user.

16. The method of claim 15 wherein the step of measuring includes the measurement device being embedded within the computing device.

17. The method of claim 15 wherein the step of measuring includes the measurement device being provided externally from the computing device.

18. The method of claim 15 wherein the step of receiving further includes the user data further including subjective information as provided by the user, the subjective information including at least one of (i) a type, strain and potency of marijuana consumed by the user, (ii) a method of consumption of the marijuana consumed by the user, and (iii) a location of purchase of the marijuana consumed by the user.

19. The method of claim 15 further comprising accessing an administrative device application that is provided within an administrative computing device by an administrative entity, the administrative device application providing the administrative entity with access to the user data stored within the database.

20. A system for leveraging user data of a user based on a presence of at least one cannabinoid in the blood of the user, the system being usable with a database that is configured to store the user data, the system comprising:
a device application that is adapted for use on a computing device, the device application being accessible by the user, the device application being configured to (i) receive the user data of the user based on the presence of the at least one cannabinoid in the blood of the user, and (ii) upload the user data to the database; and
a controller including a processor that is configured to control operation of the device application.
